(19) United States
(12) Patent Application Publication
(10) Pub. No.: US 2012/0143685 A1
(43) Pub. Date: Jun. 7, 2012

(54) COMMISSION AND MARKETING SYSTEM AND METHOD

(76) Inventor: Paul Colin Miller, Glencoe, IL (US)

(21) Appl. No.: 12/960,144

(22) Filed: Dec. 3, 2010

(51) Int. Cl. G06Q 30/00

(52) U.S. Cl. 705/14.52

(57) ABSTRACT

Embodiments of the invention relate generally to systems and methods for using historical purchase records to predict future purchases, and, more particularly, to systems, and methods for using such records to determine items that are likely to be purchased as replacements for items claimed as lost on an insurance claim. Purchase likelihood data based on insurance claims and purchases made by claimants is generated based on received loss claims and purchase records. The purchase likelihood data relates a type of loss to certain replacement items.

### TECHNICAL FIELD

Embodiments of the invention relate generally to systems and methods for using historical purchase records to predict future purchases, and, more particularly, to systems, and methods for using such records to determine items that are likely to be purchased as replacements for items claimed as lost on an insurance claim.

### BACKGROUND OF THE INVENTION

Consumers and businesses often purchase insurance to cover losses to property. In many cases, insurance relating to a home or a business may cover more than just the physical structure. For example, a typical homeowner's policy covers losses of items within the home, such as furniture, clothing, electronics, appliances, artwork, jewelry, and other items. A business policy may cover inventory and fixtures. Renter's insurance may cover many of the same items.

When a loss occurs, conventional practice is to have the insurance company (the “issuer”) assess the damage, estimate the loss, and provide a live check to the insured. In some instances, policies also cover recurring incidental expenses, such as hotel bills, food, transportation, and the like. While the issuer of the policy may control the amount of the check, it cannot determine how the insured will actually use the money, either initially or over time. Moreover, issuing live checks is expensive, and prone to loss and fraud.

The retail industry has, over the past few years, actively embraced the “stored-value card” or “debit card” concept. These cards provide the holder with a pre-defined spending limit based on either a bank-account balance or a set amount associated with the card. The cardholder may use the card at participating retail establishments to purchase goods and services until the funds associated with the card are exhausted. Because each use of the card creates an individual transaction record, a database of historical purchases can be compiled.

Similarly, insurance companies maintain records of claims made against the policies they write. For example, a homeowner may make a claim against her homeowners policy after a fire, and, as part of the claim, list specific items (e.g., a television, specific pieces of furniture, kitchenware, clothing, etc.) for which she expects to be reimbursed. Currently, there is no method for analyzing the actual transactions records generated by purchases in light of loss claims to determine which products a claimant is most likely to purchase, where and from whom the are likely to purchase it from, and how much they are likely to spend.

Accurate prediction of the items an insured person is likely to purchase, based on historical purchases of others having lost similar items or having a similar profile, would provide valuable information to retail and other commercial establishments and assist them in their marketing and advertising strategies. Moreover, such capabilities would provide opportunities for the insurers or third-party analytics firms to collect commissions based on referrals of claimants to brick-and-mortar and/or ecommerce establishments for purchases.

### BRIEF SUMMARY OF THE INVENTION

In one aspect of the invention, a system is provided for generating and providing purchase likelihood data based on insurance claims and purchases made by claimants. The system includes a data storage module for receiving and storing loss claims and purchase records. The loss claims identify one or more claimants (e.g., individuals or companies filing a loss against an insurance policy) and each purchase record identifies a claimant and one or more items being purchased that relate to the claimant's loss. A rules engine derives purchase likelihood data from the loss claims and the purchase records; the purchase likelihood data relates a type of loss to specific replacement items. The derivation of purchase likelihood data is desirably repeated as new loss claims and purchase records are received in order to refine the data and increase its predictive value. The system further includes a messaging module for transmitting an offer to a subsequent claimant to purchase a replacement item based on the purchase likelihood data.

In some instances, the transmitted offer includes an executable link directing the subsequent claimant to a website at which she may purchase a replacement item. The system may also include a commission component. In such cases, the commercial entity that owns, runs or otherwise operates the website (or in other cases, a brick-and-mortar storefront) may pay a commission for the referral. The commission may be calculated based on one or more commercial terms negotiated among the insurer, the retail or commercial establishment, and/or a third party operating various components or embodiments of the invention. The data storage module may, in some cases, receive a new loss claim (or claims) from a new claimant, in which case the rules engine then determines a type of loss (e.g., consumer electronics, appliances, clothing, jewelry, etc.) associated with the new loss claim and generates an offer to the new claimant for purchase of an item based on the derived purchase likelihood relating to the loss type.

Deriving the purchase likelihood data may, in some cases, include matching the claimant associated with loss claims with the claimant associated with the purchase record to determine which product was purchased to replace a lost item (or items). Certain loss claims and/or purchase records may be weighted to increase or decrease their relative contribution to the resulting purchase likelihood data. For example, more recent purchase records may be over-weighted, whereas older records may be under-weighted. In certain instances, the weighting may be a function of the elapsed time between a loss claim and a purchase for a similar item. In some cases, the reduction in weighting over time may depend on other attributes, such as the type of loss or the amount of the purchase. Claimant demographics (age, gender, location, income, employment status, etc.) may also be used to determine weightings of individual loss claims or purchase records when computing the likelihood data. The type of merchandise or services purchased may also influence the purchase likelihood data, and thus be used to further refine the weightings.

In another aspect of the invention, a computer-implemented method is provided for generating and providing purchase likelihood data based on insurance claims and purchases made by claimants. The computer-implemented method comprises receiving loss claims and purchase records, each having a claimant associated therewith. Based on the received loss claims and purchase records, purchase likelihood data relating a type of loss to certain replacement items is derived. The purchase likelihood data is stored in a database and the process is repeated in order to refine the data based on subsequently received claims and purchase data.

In some instances, new claims and purchase data may be received, and based on a loss type associated with the newly received data, an offer to purchase an item is generated and sent to the claimant. The offer may be generated based, for example, on the purchase likelihood data and the loss type. In some cases, the offer may be electronic (e.g., and email, text message, on-line advertisement, etc.), directing the claimant to a website at which the item may be viewed and/or purchased. In some instances, a commission may be calculated and paid to the entity referring the claimant to the website. The commission may be calculated based on one or more commercial terms negotiated among the insurer, the retail or commercial establishment, and/or a third party operating various components or embodiments of the invention.

Deriving the purchase likelihood data may, in some cases, include matching the claimant associated with loss claims with the claimant associated with the purchase record to determine which product was purchased to replace a lost item (or items). As explained above, certain loss claims and/or purchase records may be weighted to increase or decrease their relative contribution to the resulting purchase likelihood data.

### BRIEF DESCRIPTION OF THE DRAWINGS

The present invention is described in detail below with reference to the attached drawing, wherein:

FIG. 1 is a flow chart illustrating the operation of a system in accordance with various embodiments of the invention; and

FIG. 2 is a block diagram illustrating the components of a system in accordance with various embodiments of the invention.

### DETAILED DESCRIPTION OF PREFERRED EMBODIMENTS

When a consumer or business suffers a loss of property due to fire, theft or other event, an insurance claim may be filed to cover the costs associated with replacing the lost item and/or providing ongoing living expenses for the insured party. Often, the claim arises from an insurance policy owned either by an individual, an entity (e.g., a corporation) or a couple (e.g., a husband and wife). In each case, common practice is to issue a live check in the amount deemed appropriate given the loss. For example, if a fire consumes clothing, appliances and household items in a couple's home, the couple can file a claim against their homeowners policy requesting reimbursement for the lost items. Once an amount is agreed upon, the insurer issues a check, typically made payable to the claimant.

In some cases, issuing live checks is not a preferred method of payment. For example, the rise in popularity of stored-value cards, gift cards, and similar instruments for purchasing goods and services has allowed insurance companies to issue payment cards to the claimants, who in turn use the cards to purchase replacement items. As used herein, a “card” connotes a debit card, a credit card, a gift card, an online stored-value account, or other device or instrument (either physical or electronic). The card may be associated with a financial account into which certain funds are deposited, or, in some cases, the card may have an amount encoded thereon representing the total amount that may be spent using the card. Because of the electronic nature of the purchase transactions, the card issuer, typically a bank, credit union, retail establishment or a transaction-processing company (e.g., VISA, MASTERCARD, or AMERICAN EXPRESS) can track individual purchases at a very detailed level. While the use of such data to generally predict subsequent purchases is well known, the systems and techniques described herein illustrate how such data may be used in conjunction with insurance loss data to predict how and when an individual will purchase a particular replacement item.

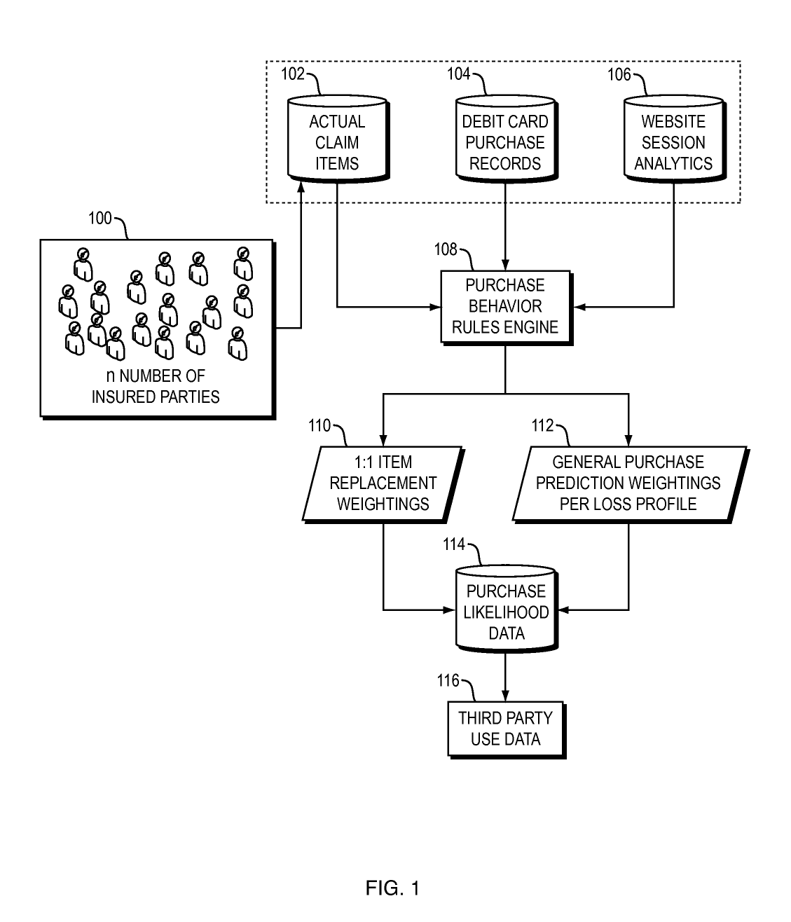

FIG. 1 illustrates a representative embodiment of the present invention in which a community of insured individuals, groups, and other parties 100 submit insurance loss claims against policies. The claims list one or more claim items 102 which may include, for example, household goods, clothing, automobiles, valuables, appliances, and, in some cases, services such as temporary housing, transportation, and food. In addition to listing the item or items the insured party is reporting as lost or damaged, each claim may also include information about the claimant, such as a name, age, location, gender, income, and other demographic information. The claims may be received electronically via an online claims-processing portal, or entered manually into a claims-processing system. In each case, the claims are stored in a data storage module for analysis and processing. In some cases, the loss claims may be stored, processed, analyzed and managed by the insurer, whereas in other instances some or all of these data-management functions may be outsourced to one or more third-party service providers.

In response to filing a loss claim, a claimant may be issued a stored-value card such that she may purchase items using funds in a financial account associated with the card or otherwise associated with the card. The items purchased may correspond specifically to the items listed in the loss claims (e.g., the same make and model refrigerator), may represent similar items (e.g., a newer-model television) and/or may be completely different items. In each case, use of the card generates purchase records 104 based on point-of-sale data and information about the claimant. The point-of-sale data may include information about the product/service being purchased (e.g., category, item number, quantity, manufacturer), the transaction itself (date, time, location), the merchant, and the claimant associated with the card. In some instances, the card may be used to purchase items from a traditional “brick-and-mortar” storefront, whereas in other cases the claimant may use the card for online purchases at a website.

Like loss claims, the purchase records may be created, stored, analyzed and processed by a single entity (e.g., a bank or card issuer or a large retain chain), whereas in other cases purchase records may be transmitted to and aggregated by a third party. In such instances, some or all of the claimant-specific data (e.g., account numbers, names, etc.) may be “scrubbed” from the data to ensure anonymity and to comply with certain data-privacy provisions. In other cases, claimant information may be retained in order to perform matches against the loss claims based on name, account number, or other uniquely identifying data.

Independently of the receipt of loss claims 102 and purchase data 104, website analytic data 106 may be used to track and analyze consumer browsing and/or purchase behavior at various e-commerce, search, social media and/or content sites. For example, pages, page views, visits, unique visitors, new visitors, repeat visitors, entry page, landing page, exit page, visit duration, referring source, internal referrer, external referrer, search referrer, click-through, click-through rate/ratio, page views per visit, and conversion statistics may be used to statistically characterize activities at a website. Such statistics may provide insight into what pages/products visitors are likely to purchase, what products users typically search for, and the page history users follow as they navigate the site.

The loss claim data 102, purchase records 104, and, in some cases, the website analytics data 106 may be collected and stored by a single entity in a central data storage module or distributed set of modules. In some cases, however, some or all of the data may be made available to a third-party via web services, APIs or other electronic data-interchange protocols. In such cases, the third party may provide data-mining and analytics services to the insurance companies, card issuers and/or retail establishments via data feeds and/or reports as a subscription or as a licensed service.

In each case, the compilation of loss claim data 102 and purchase records 104 may be analyzed using a rules engine 108. The rules engine 108 may use one or more conventional statistical analysis techniques (e.g., regression, fuzzy logic, multi-variate analysis, etc.) to identify traits, trends and other attributes that can be used to predict purchase behavior of individuals purchasing goods and/or services after filing a loss claim. For example, if purchase data and loss claim records both include a unique name or account number of the claimant/purchaser, loss claims may be matched with purchases based on the claimant's name or account number. As a result, the rules engine may identify purchasing patterns that relate particular losses (e.g., a loss claim for a mid-range plasma television) to specific purchases (e.g., a mid-range LED television from the same manufacturer). In other instances, the data may not contain specific names or account numbers on which individual loss claims and purchase records may be matched, but general trends may be determined based on the data in the aggregate.

In some cases, analysis of the data may result in one-to-one replacement weightings 110 that indicate a mapping from a particular loss item to a specific replacement purchase item. For example, a claimant may have submitted a loss claim after a house fire and listed a refrigerator (including the manufacturer, the particular model number and possibly historical purchase data) as one of the items to be replaced. Loss claims and purchase records from previous claimants submitting claims for loss of the same or similar model refrigerator may indicate that a particular model is the most likely model to be purchased as a replacement. In a similar fashion, other models may also be identified as commonly selected replacements. In such cases, the claimant may be presented with an advertisement or directive from a manufacturer or retailer of one or more of the identified models, knowing that the claimant is likely to make the purchase. In some instances, the claimant may be presented with an ad for a different model (e.g., one that the data indicates is less likely to be purchased) but the manufacturer or retailer has a higher profit margin or excess inventory.

In some embodiments, individual (or groups of) loss claims 102 and/or purchase records 104 may be also be weighted based on one or more attributes of the data. For example, purchase records having a more recent date may more accurately predict which product a subsequent purchaser will select. Likewise, demographic data regarding the purchaser (sex, age, income level, geographic location, occupation, etc.), which may be linked to the purchase records based on an account and/or policy number, may be used to weight specific records. For example, a filter may be applied to the loss claims and purchase records to identify those records associated with males between 30 and 35 years old, living in urban neighborhoods, making between $50,000 and $75,000 annually. The resulting corpus of data may then be weighted during the analysis phase more heavily than other data to predict which product or service an individual in that demographic is likely to purchase. In some instances, negative weightings may be applied to certain records where negative correlations are found.

In other cases, general purchase predictions 112 may be derived from the data. In contrast to the one-to-one replacement weightings that identify a specific product that an individual is likely to purchase as a replacement after submitting a claim for a lost item, the general purchase prediction weightings are based on a loss profile of the claimant generally. For example, the claimant may belong to a demographic group having certain purchase patterns and, as a result, particular items suggested by these patterns may be identified as likely replacement purchases independent of the item actually identified in a loss claim.

Both the one-to-one replacement weightings 110 and the general purchase prediction weightings 112 may be combined into a centralized purchase likelihood data 114 data store for further analysis, licensing and distribution. In some cases, for example, the purchase likelihood data 114 is scrubbed of all indicators of sources of the data (e.g., names, account numbers, policy numbers, etc.) such that the data is anonymous. The data may also be aggregated across claimants based on one or more claimant or transactional attributes to determine purchase likelihood data for particular geographic areas, socio-economic groups, seasons, products, etc. Once the data is aggregated in such a fashion, it may me provided to third parties 116 and used to support marketing, product development and advertising campaigns.

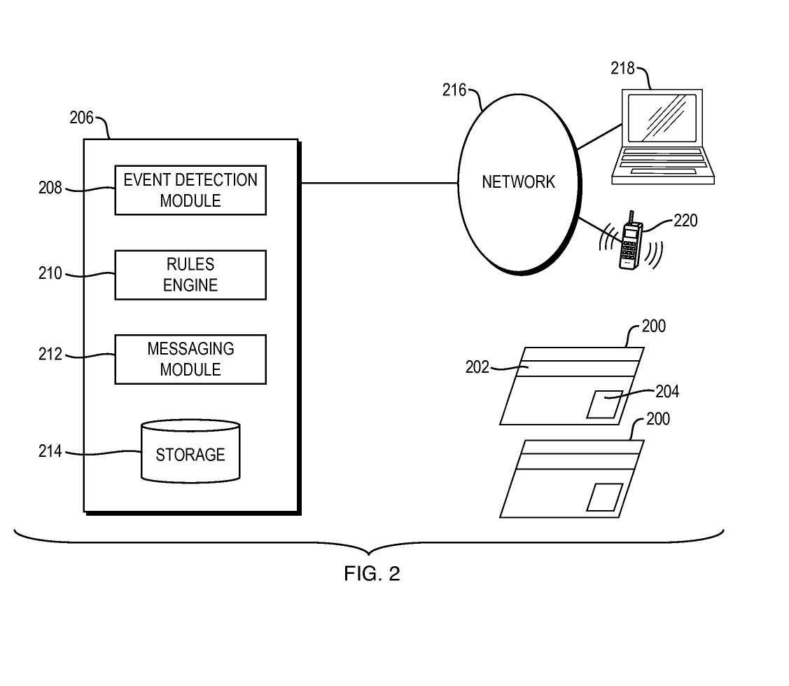

FIG. 2 illustrates a system for implementing the techniques described above. A card or cards(s) 200 may have stored thereon computer-readable instructions and/or data governing usage restrictions, user data and other information by means, e.g., of a magnetic strip 202, an embedded chip or memory device 204, or both. The card 200 can be, for example, a debit card, a credit card, a transfer funds card, a smart card, a stored-value card, a gift card, an ATM card, a security card or an identification card. The card 200 may also include components for providing or processing either account, identity, payment, health, transactional, or other information and communicating with central processing units or computers operated by the providers of services, such as credit card institutions, banks, health care providers, universities, retailers, wholesalers or other providers of goods or services employers, or membership organizations. Card features may also enable the card to communicate with or be accessed by other devices, including those used by retailers (e.g., point-of-sale computers), and personal computers used in other business applications or at home (for example, a personal computer having a built-in or attached card reader).

A central computing device 206 processes purchase transactions related to the use of the card 200, and includes an event-detection module 208, a rules engine 210, a messaging module 212, and in some instances one or more data storage devices 214. The data storage devices 214 and/or central computing device 206 may store financial information pertaining to the account tied to the card 200 as well as data relating to the loss claims, card purchases and/or web analytics. In some cases, the computing device 206 may receive or access one or more of these data sources from the insurance company, financial institution and/or website analytics company in real time via a web service, data feed, or other data-transfer protocol. The central computer device 206 may send and receive communications regarding the loss records and card usage over a network 216, such as the Internet or, in some cases, a private network. Cardholders may use one or more computing and/or communication devices (e.g., a computer 218 or a hand-held device 220) to send and receive account information, claims and/or purchase data from the central computing device 206.

For example, the central computing device 206 may receive, via the messaging module 212, messages and/or events directly from retail establishments (or indirectly from card issuers) related to the use of the card 200 for purchasing goods and services. The event-detection module 208 determines when transactional events (e.g., use of a card to make a purchase) registered by the messaging module 212 are relevant to the processing rules of rules engine 210. When a relevant event is detected, the rules engine 210 performs the analysis and aggregation functions described above to derive the replacement and purchase prediction weightings.

The components of the central computing device 206 may be implemented by computer-executable instructions, such as program modules, being executed by a conventional computer. Generally, program modules include routines, programs, objects, components, data structures, etc. that performs particular tasks or implement particular abstract data types. Those skilled in the art will appreciate that the invention may be practiced with various computer system configurations, including hand-held wireless devices such as mobile phones or PDAs, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer-storage media including memory storage devices.

The central computing device 206 may comprise or consist of a general-purpose computing device in the form of a computer including a processing unit, a system memory, and a system bus that couples various system components including the system memory to the processing unit. Computers typically include a variety of computer-readable media that can form part of the system memory and be read by the processing unit. By way of example, and not limitation, computer readable media may comprise computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit. The data or program modules may include an operating system, application programs, other program modules, and program data. The operating system may be or include a variety of operating systems such as Microsoft WINDOWS operating system, the Unix operating system, the Linux operating system, the Xenix operating system, the IBM AIX operating system, the Hewlett Packard UX operating system, the Novell NETWARE operating system, the Sun Microsystems SOLARIS operating system, the OS/2 operating system, the BeOS operating system, the MACINTOSH operating system, the APACHE operating system, an OPENSTEP operating system or another operating system of platform.

Any suitable programming language may be used to implement without undue experimentation the data-gathering and analytical functions described above. Illustratively, the programming language used may include assembly language, Ada, APL, Basic, C, C++, C*, COBOL, dBase, Forth, FORTRAN, Java, Modula-2, Pascal, Prolog, Python, REXX, and/or JavaScript for example. Further, it is not necessary that a single type of instruction or programming language be utilized in conjunction with the operation of the system and method of the invention. Rather, any number of different programming languages may be utilized as is necessary or desirable.

The computing environment may also include other removable/nonremovable, volatile/nonvolatile computer storage media. For example, a hard disk drive may read or write to nonremovable, nonvolatile magnetic media. A magnetic disk drive may read from or writes to a removable, nonvolatile magnetic disk, and an optical disk drive may read from or write to a removable, nonvolatile optical disk such as a CD-ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The processing unit that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of the invention.

The network 216 may include a wired or wireless local area network (LAN) and a wide area network (WAN), wireless personal area network (PAN) and/or other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Computers may be connected over the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocol. Furthermore, components of the system may communicate through a combination of wired or wireless paths.

While particular embodiments of the invention have been illustrated and described in detail herein, it should be understood that various changes and modifications might be made to the invention without departing from the scope and intent of the invention. From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

1. A system for providing purchase likelihood data, the system comprising:
a data storage module for receiving a plurality of loss claims and a plurality of purchase records, each loss claim identifying a claimant and at least one loss item and each purchase record identifying a claimant and at least one purchased item relating to the claimant's loss;
a rules engine for deriving, based on the stored loss claims and the purchase records, purchase likelihood data relating a type of loss to specific replacement items; and
a messaging component for transmitting an offer to the claimant to purchase at least one replacement item based on the derived purchase likelihood data.

2. The system of claim 1 wherein the rules engine repeats the deriving step as new loss claims and purchase records are stored in order to refine the purchase likelihood data.

3. The system of claim 1 wherein the transmitted offer comprises an executable link directing the claimant to a website, thus facilitating a purchase of the at least one replacement item.

4. The system of claim 3 further comprising a commission component for calculating one or more commissions to be paid by an operator of the website in exchange for the purchase of the at least one replacement item.

5. The system of claim 1 wherein the rules engine is configured to determine, in response to a new loss claim from a new claimant, a type of loss associated with the new loss claim, and to generate an offer to the new claimant for purchase of an item based on the derived purchase likelihood relating to the loss type.

6. The system of claim 1 wherein the rules engine matches the claimant associated with the loss claim with the claimant associated with the purchase record.

7. The system of claim 1 wherein the rules engine determines weightings for at least a subset of the stored purchase records and the stored loss claims, the weightings representing a relative contribution of the loss claims to the corresponding purchase likelihood data.

8. The system of claim 7 wherein the weightings are based at least in part on dates attributed to the purchase records and dates attributed to the corresponding loss claims.

9. The system of claim 7 wherein the weightings are based at least in part on demographic data attributed to the claimant.

10. The system of claim 7 wherein the weightings are based at least in part on an amount attributed to the purchase records and amounts attributed to the corresponding loss claims.

11. The system of claim 7 wherein the weightings are based at least in part on commissions paid pursuant to purchase of the replacement items by the claimants.

12. The system of claim 7 wherein the weightings are based at least in part on merchandise and service categories attributed to the purchase records and the corresponding loss claims.

13. A computer-implemented method for providing purchase likelihood data, the method comprising:
receiving, at a storage device, a plurality of loss claims each identifying a loss claimant and at least one loss item;
receiving, at the storage device, a plurality of purchase records each identifying a claimant and at least one purchased item;
deriving, based on the stored loss claims and the store purchase records, purchase likelihood data relating a type of loss to one or more replacement items; and
storing the purchase likelihood data in a database.

14. The method of claim 13 further comprising repeating the deriving step as new loss claims and purchase records are received in order to refine the purchase likelihood data.

15. The method of claim 13 further comprising receiving a new loss claim from a claimant, determining a type of loss associated with the claim, and offering at least one item to the claimant for purchase based on the derived purchase likelihood relating to the loss type.

16. The method of claim 13 wherein the offering step comprises electronically directing the claimant to a website at which the claimant may purchase the at least one item.

17. The method of claim 13 wherein the purchase likelihood data is derived, at least in part, by matching the claimant associated with the loss claim with the claimant associated with the purchase record.

18. The method of claim 13 further comprising attributing weightings to at least a subset of the stored purchase records and stored loss claims, the weightings representing a relative contribution of the loss claims to the corresponding purchase likelihood data.

19. The method of claim 18 wherein the weightings are based at least in part on dates attributed to the purchase records and dates attributed to the corresponding loss claims.

20. The method of claim 18 wherein the weightings are based at least in part on demographic data attributed to the claimant.

21. The method of claim 18 wherein the weightings are based at least in part on amounts attributed to the purchase records and amounts attributed to the corresponding loss claims.

22. The method of claim 18 wherein the weightings are based at least in part on commissions paid pursuant to purchase by the claimants of the replacement items.

23. The method of claim 18 wherein the weightings are based at least in part on merchandise and service categories attributed to the purchase records and the corresponding loss claims.

24. The method of claim 13 wherein the purchase records comprise data generated from electronic payment transactions.

25. The method of claim 13 wherein the loss claims comprise data generated from claims filed pursuant to insurance policies.
